(19) United States
(12) Patent Application Publication
(10) Pub. No.: US 2026/0187172 A1
(43) Pub. Date: Jul. 2, 2026

(54) USING INTERMEDIATE EMBEDDINGS OF LANGUAGE MODEL NEURAL NETWORKS TO SELECT DIGITAL COMPONENTS

(71) Applicant: GOOGLE LLC, Mountain View, CA (US)

(72) Inventor: Nicholas James Reid, Seattle, WA (US)

(21) Appl. No.: 18/858,416

(22) PCT Filed: Jul. 18, 2023
(86) PCT No.: PCT/US2023/028041

§ 371 Date: Oct. 21, 2024

(51) Int. Cl. G06F 16/9538; G06F 16/9535

(52) U.S. Cl. CPC G06F 16/9538; G06F 16/9535

(57) ABSTRACT

Methods, systems, and apparatus, including computer programs encoded on computer storage media, for using intermediate embeddings of language model neural networks to select digital components is described. A natural language prompt is received from a user and processed by a language model neural network to generate a response. An intermediate embedding is obtained. Based on the intermediate embedding, one or more target stages is determined from among a plurality of different stages included in a user journey during which a user performs different actions to perform a computer-implemented task. One or more target digital components is selected from respective candidate digital components mapped to the one or more target stages. The one or more target digital components are presented for display to the user together with the response to the natural language prompt that has been generated by the language model neural network.

### BACKGROUND

This specification relates to machine learning.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

The present disclosure describes using intermediate embeddings of language model neural networks to select digital components. A system can be implemented as computer programs on one or more computers in one or more locations that selects target digital components for presentation using an intermediate embedding of a language model neural network that is generated during the processing of a prompt to generate an output. For example, the language model neural network can be a Transformer-based language model neural network or a recurrent neural network-based language model.

According to an aspect, there is provided a method performed by one or more computers, comprising: receiving a natural language prompt from a user; processing, by a language model neural network, the natural language prompt to generate a response to the natural language prompt; obtaining an intermediate embedding generated by the language model neural network during the processing of the natural language prompt to generate the response; determining, based on the intermediate embedding, one or more target stages from among a plurality of different stages included in a user journey during which a user performs different actions to perform a computer-implemented task; selecting, from respective candidate digital components mapped to the one or more target stages, one or more target digital components; and presenting, for display to the user, the one or more target digital components together with the response to the natural language prompt that has been generated by the language model neural network.

Other embodiments of this aspect include corresponding systems and computer programs recorded on one or more computer storage devices, each configured to perform the actions of the above method aspect.

The foregoing and other embodiments can each optionally include one or more of the following features, alone or in combination. In particular, one embodiment includes all the following features in combination.

The computer-implemented task may comprise: navigating from a source web page, through a plurality of web pages, to arrive at a landing web page, wherein the landing web page represents a solution to a problem represented by the source web page.

The plurality of different stages may be a progression of different stages that comprise a problem awareness stage, followed by a solution provider awareness stage, followed by a solution consideration stage, followed by a solution comparison stage, and followed by a solution implementation stage.

The intermediate embedding may comprise: an output of an intermediate neural network layer of the language model neural network.

Determining the one or more target stages from among the plurality of different stages included in the user journey may comprise: computing a distance in a latent space between the intermediate embedding and each reference embedding of a plurality of reference embeddings, wherein the plurality of reference embeddings were generated by the language model neural network based on processing history natural language prompts provided by different users at different reference stages included in respective reference user journeys; selecting one or more reference embeddings having distances that satisfy a distance threshold; identifying one or more reference stages within the respective reference user journeys during which the one or more reference embeddings were generated by the language model neural network; and using the one or more reference stages as the one or more target stages.

The method may comprise: using the language model neural network to generate, based on information available on the landing web page, additional history natural language prompts that represent the history natural language prompts that would be provided by the different users at the different reference stages included in the respective reference user journeys.

Selecting the one or more target digital components may comprise: receiving, from a digital component provider, and for each stage of the plurality of different stages included in the user journey, respective candidate digital components associated with each stage.

Particular embodiments of the subject matter described in this specification can be implemented so as to realize one or more of the following advantages.

By using the intermediate embedding of a language model neural network that has been generated during the processing of a prompt to generate an output, the selection of additional content, e.g., digital components, for presentation together with the output can be made significantly faster than selecting the additional content based on subsequently analyzing the output after it is generated, i.e., because the selection of the additional content can be performed at least partly concurrently with the generation of the output. This reduces latency in providing and presenting the content, which can also reduce errors that occur that might occur while waiting for the additional content.

By measuring the distances between the intermediate embedding and reference embeddings mapped to known stages within respective user journeys in a latent space, the system can more flexibly and accurately analyze the context of the prompt which facilitate the identification of more suitable digital components for presentation. In some examples, these digital components, when presented to a user, will assist the user to provide prompts, e.g., in subsequent conversation turns, in a manner that can shorten an overall number of conversation turns that would otherwise be required to accomplish a particular task. Thus, the cost associated with computing resources (e.g., memory, storage, data transmission, and computing power) that are required to process extra prompts by the language model is also reduced. Further, the likelihood of unsuitable content being displayed in response to the prompts can be reduced, without introducing significant latency when displaying suitable content.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which one or more target digital components can be presented, according to an implementation of the present disclosure.

FIG. 2 is an example illustration of a user journey to perform a computer-implemented task, according to an implementation of the present disclosure.

FIG. 3 illustrates example operations for selecting target digital components for presentation, according to an implementation of the present disclosure.

FIG. 4 is a flow diagram of an example process for selecting and presenting target digital components together with a response to a natural language prompt, according to an implementation of the present disclosure.

FIG. 5 is a flow diagram of sub-steps of one of the steps of the process of FIG. 4, according to an implementation of the present disclosure.

FIG. 6 is a block diagram of an example computer system that can be used to perform operations described herein, according to an implementation of the present disclosure.

Like reference numbers and designations in the various drawings indicate like elements.

### DETAILED DESCRIPTION

The following detailed description describes using intermediate embeddings of language model neural networks to select digital components, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

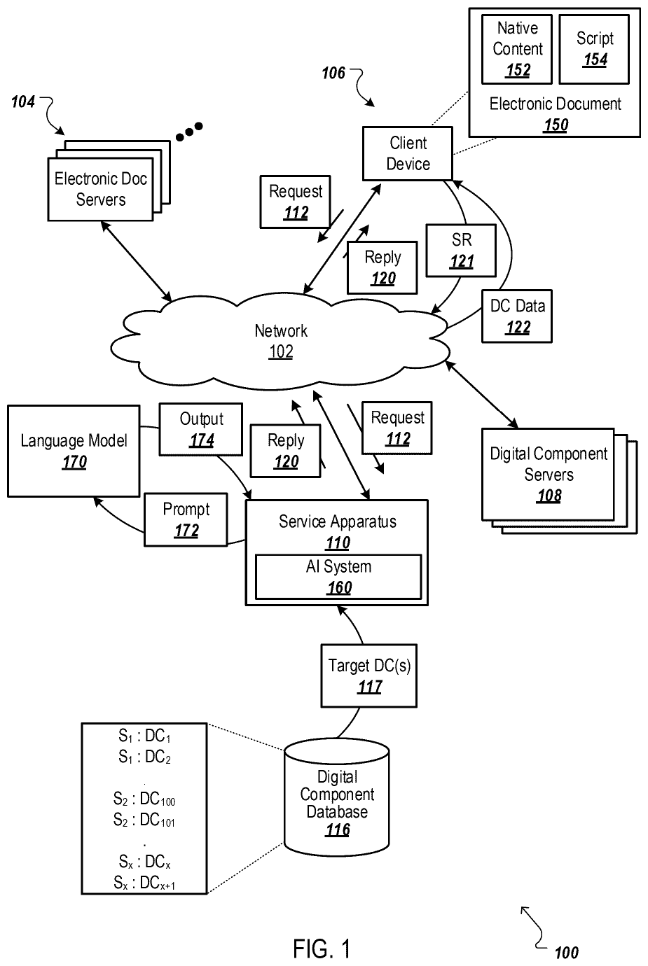

FIG. 1 is a block diagram of an example environment in which one or more target digital components can be presented, according to an implementation of the present disclosure. As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

The example environment 100 includes a network 102, such as a local area network (LAN), a wide area network (WAN), the Internet, or a combination thereof. The network 102 connects electronic document servers 104, client devices 106, digital component servers 108, and a service apparatus 110. The example environment 100 may include many different electronic document servers 104, client devices 106, and digital component servers 108.

A client device 106 is an electronic device capable of requesting and receiving online resources over the network 102. Example client devices 106 include personal computers, gaming devices, mobile communication devices, digital assistant devices, wearable devices (e.g., smart watches), augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include the outputs of a language model, web pages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) includes a script (e.g., script 154) that references the service apparatus 110, or a particular service provided by the service apparatus 110. In these situations, the script is executed by the client device 106 when the given electronic document is processed by the client device 106.

Execution of the script configures the client device 106 to generate a request for digital components 112 (referred to as a “component request”), which is transmitted over the network 102 to the service apparatus 110. For example, the script can enable the client device 106 to generate a component request 112 that is packetized and includes a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, e.g., the target digital components 117 or other digital components from the database 116, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., Uniform Resource Locator (URL)) to an electronic document (e.g., a webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, and a type of device at which the digital component will be displayed, such as a mobile device or tablet device). Component requests 112 can be transmitted, for example, over a packetized network.

The service apparatus 110 includes an artificial intelligence system 160 that implements one or more language model neural networks 170, also referred to simply as “language models,” which can include large language models. A large language model (“LLM”) is a model that is trained to generate and understand human language and/or computer code. LLMs are trained on massive datasets of text and/or code, and they can be used for a variety of tasks. For example, LLMs can be trained to translate text from one language to another; summarize text, such as web site content, search results, news articles, or research papers; answer questions about text, such as “What is the capital of Georgia?”; create chat bots that can have conversations with humans; and generate creative text, such as poems and stories (in a natural language) and computer code (in a programming language).

In some implementations, the language model 170 is pre-trained, i.e., trained on a language modeling task that does not require providing evidence in response to user questions, and the service apparatus 110 (e.g., using AI system 160) causes the language model 170 to generate output sequences according to pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

The language model 170 can be configured through training to perform any kind of language modeling tasks, i.e., can be configured to receive any kind of input prompt 172, also referred to simply as “prompt,” and to generate any kind of output sequences 174, also referred to simply as “output,” based on the input 172. Typically, the AI system 160 receives a prompt 172 that is submitted to the language model 170, and causes the language model 170 to generate the output 174 that is a response to the prompt 172.

As a particular example, the language model 170 can be configured to perform a summarization task. In this example, the AI system 160 receives the prompt 172, e.g., either as part of or in addition to a component request 112 or another request for an output 174, from a user of the client device 106. The prompt 172 includes or references a set of online sources and, optionally, an instruction that requires the AI system 160 to generate a summarization of the set of online sources. To initiate creation of the output 174, the AI system 160 submits the received prompt 172 to the one or more language models 170, which use the prompt 172 to evaluate the information found at the online sources specified in the prompt 172, and generate the output 174 that summarizes the information.

The service apparatus 110 chooses digital components (e.g., third-party content, such as video files, audio files, images, text, gaming content, augmented reality content, and combinations thereof, which can all take the form of advertising content or non-advertising content), e.g., the target digital components 117, that will be presented together with the output 174 that is a response to the prompt 172.

In some implementations, a digital component is selected in less than a time threshold to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

As another example, as the delay in providing the digital component to the client device 106 increases, it is more likely that a topic that the digital component relates to is no longer relevant to the present conversation turns between the user and the language model 170 when the digital component is delivered to the client device 106. As a result, a user's experience with the AI system 160 is negative impacted.

Further, delays in providing the digital component can result in a failed delivery of the digital component. For example, if a conversation is no longer ongoing at a client device 106 and the prompt 172 has become obsolete when the digital component is provided.

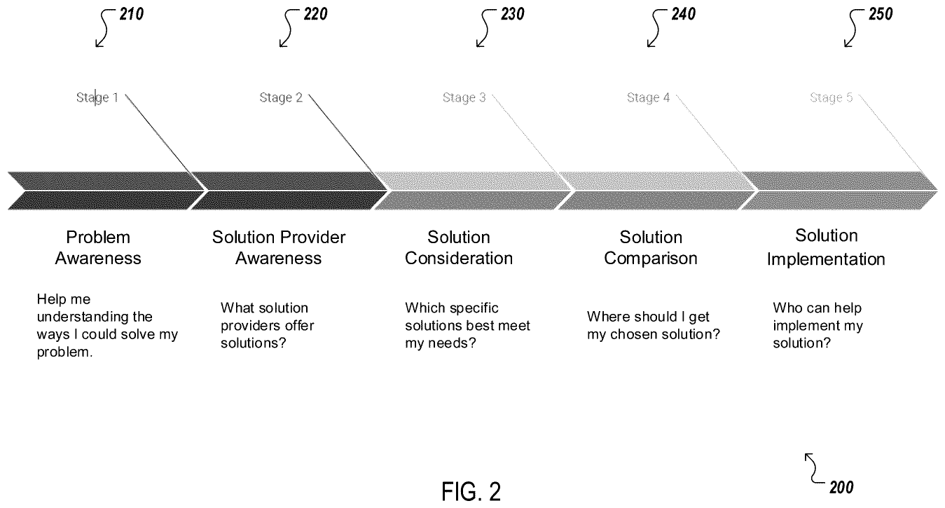

In some implementations, the service apparatus 110 is implemented in a distributed computing system that includes, for example, a server and a set of multiple computing devices that can operate together to execute the operations of the language model 170. The set of multiple computing devices can also operate together to use the techniques described below with reference to FIGS. 2-5 to identify and distribute a set of target digital components that are eligible to be presented together with the outputs 174 in response to the prompts 172 from among a corpus of a plurality of available digital components (DC₁₋ₓ).

In particular, the plurality of available digital components are stored in a database, e.g., the digital component database 116 of FIG. 1, where they are indexed to different stages within respective user journeys for performing a computer-implemented task. A specific example of a user journey will be described in FIG. 2. In brief, each user journey represents a process during which a user performs actions (or operations) to accomplish a final goal of the task; each user journey is partitioned into an ordered sequence of stages during which different actions are performed by the user.

As illustrated in FIG. 1, the digital component database 116 stores these available digital components in key-value pairs, where the keys represent the different stages of the user journeys, and the values represent available digital components. Each key (stage) can reference the corresponding values (digital components) that are mapped to the key. The digital component database 116 can have any of a variety of known data structure to store keys and the keys' associated values. These available digital components can be received by the service apparatus 110 from one or more digital component providers, e.g., third-party content providers, for example, from multiple digital component provider that corresponds respectively to the multiple different stages.

As illustrated, digital components DC₁₋₂ are stored in association with a first stage S₁, digital components DC₁₀₀₋₁₀₁ are stored in association with a second stage S₂, digital components DCₓ₋ₓ₊₁ are stored in association with a third stage Sₓ, and so on. The digital component database 116 thus stores a mapping between each of the different stages within the user journey and the corresponding digital components that are associated with the stage. Each stage within the user journey can map to the same or different numbers (or categories) of digital components. For example, different stages can map to non-overlapping or partially overlapping subsets of all of the available digital components stored in the digital component database 116.

The identification of the eligible digital component to be presented together with the output 174 that is a response to the prompt 172 includes identifying, by the service apparatus 110 and based on the prompt 172, a target stage within the user journey, and then selecting one or more digital components that are mapped to the target stage as eligible digital component for presentation. The identification of target stage includes using the intermediate embeddings generated by one or more intermediate neural network layers of the language model 170 during the processing of the prompt 172, as will be described further below.

Generally, the service apparatus 110 can select any number of target digital components that are mapped to the identified target stage. In some implementations, the service apparatus 110 can then generate and transmit, over the network 102, reply data 120 (e.g., digital data representing a response) that enable the client device 106 to integrate the set of target digital components into the output 174, such that the set of target digital components (e.g., target third-party content) and the content of the output 174 generated by the language model 170 are presented together at a display of the client device 106.

In some implementations, the client device 106 executes instructions included in the reply data 120, which configures and enables the client device 106 to obtain the set of target digital components from one or more digital component servers 108. For example, the instructions in the reply data 120 can include a network location (e.g., a URL) and a script that causes the client device 106 to transmit a server request (SR) 121 to the digital component server 108 to obtain a given winning digital component from the digital component server 108. In response to the request, the digital component server 108 will identify the given target digital component specified in the server request 121 (e.g., within the database 116 storing multiple digital components) and transmit, to the client device 106, digital component data (DC Data) 122 that presents the given target digital component together with the output 174 at the client device 106.

When the client device 106 receives the digital component data 122, the client device will render the digital component (e.g., third-party content), and present the digital component at an appropriate location. For example, the script 154 can create a walled garden environment, such as a frame, that is presented within, e.g., beside, the native content 152 of the electronic document 150. In some implementations, the digital component is overlaid over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

FIG. 2 is an example illustration of a user journey to perform a computer-implemented task, according to an implementation of the present disclosure. The computer-implemented task can be any of a variety of tasks that require that a user perform actions using one or more user computing devices, e.g., the client device 106. The actions can be performed in one or more software applications installed on the user computing device that each has a respective user interface. For example, the actions can include to make selection input by, e.g., touch, gesture, or click, to provide text, audio, or image input, and so on.

As a particular example, the computer-implemented task can involve identifying certain resources from among a wide variety of resources, such as image files, audio files, video files, and web pages, that are available on the Internet, as target resources and, in some cases, utilize the identified target resources to generate one or more solutions to a problem that exists, e.g., in a real-world environment or in a computer environment.

In this example, to accomplish such a computer-implemented task, the user typically navigates through, e.g., selects, a plurality of web pages to acquire information of interest. During the navigation, the user may submit prompts 172 to the AI system 160 and correspondingly receive outputs 174 generated by the language model 170 that include or otherwise characterize the resources. Additionally or alternatively, the user may submit queries to a search engine accessible by the service apparatus 110, which is capable of providing information about the resources in a manner that is useful to the user.

The user generally performs different actions at each of the plurality of stages included in the user journey. For example, at different stages of the user journey, the user selects distinct content presented on the user computing device, provides distinct text, audio, or image inputs, or some combinations of these.

In some implementations, the computer-implemented task in the example of FIG. 2 can be a task of identifying, from a plurality of web pages, a landing web page that represents a solution to the user's problem. For example, the landing web page can describe an item including, but not limited to, a good, a product, a service, an experience, or the like that can be utilized as the problem solution.

As illustrated in FIG. 2, the user journey includes a progression of five successive stages. The beginning stage is a problem awareness stage 210. The problem awareness stage 210 can begin with the user viewing a source web page in a web browser of the client device 106. At the problem awareness stage 210, the user become aware of a particular problem that exists. Logically, the user can submit prompts 172 that define the particular problem to the language model 170 seeking answers about various ways to solve the particular problem. In response, the language model 170 returns, as the outputs 174, information relevant to the prompts 172 in a manner to reduce an amount of time the user sifts through individual resources, e.g., individual image files, audio files, video files, and web pages, to determine the information being sought.

From the problem awareness stage 210, the user journey progresses to a solution provider awareness stage 220. The solution provider awareness stage 220 can begin after the user becomes aware of various possible solutions to the particular problem. At the problem awareness stage 210, the user can submit prompts 172 that describe the possible problem solutions to the language model 170 seeking information about existing solution providers that offer these solutions and, in response, receive outputs 174 from the language model 170 that include information relevant to the prompts 172.

From the solution provider awareness stage 220, the user journey progresses to a solution consideration stage 230. The solution consideration stage 230 can begin after the user becomes aware of the existing solution providers that offer the possible solutions to the particular problem. At the solution consideration stage 230, the user can submit prompts 172 that describe the existing solution providers to the language model 170 seeking information about which specific problem solution(s) offered by one or more of the existing solution providers satisfy the needs of the user facing the problem and, in response, receive outputs 174 from the language model 170 that include information relevant to the prompts 172.

From the solution consideration stage 230, the user journey progresses to a solution comparison stage 240. The solution comparison stage 240 can begin after the user becomes aware of the specific problem solution(s) that satisfy the needs of the user facing the problem. At the solution comparison stage 240, the user can submit prompts 172 that describe the specific problem solution to the language model 170 seeking information about which specific solution provider is capable of providing the specific problem solution(s) and, in response, receive outputs 174 from the language model 170 that include information relevant to the prompts 172.

From the solution comparison stage 240, the user journey progresses to the final stage of the solution implementation stage 250. The solution implementation stage 250 can begin after the user has identified on the specific solution provider, e.g., after the user reaches a landing web page in the web browser of the client device 106 that corresponds to the specific solution provider. At the solution implementation stage 250, the user can submit prompts 172 that describe the specific problem solution provided by the identified specific solution provider to the language model 170 seeking information about possible ways of implementing the specific problem solution and/or what other solutions are required for solving the particular problem and, in response, receive outputs 174 from the language model 170 that include information relevant to the prompts 172.

A specific example of a user journey to accomplish a task is now described. It will be appreciated that alternative user journeys may accomplish the same task, and different users may perform different actions during the alternative user journeys to accomplish the same task (but the stages included in those alternative user journeys to accomplish the same task will generally be similar to each other, e.g., the alternative user journeys will include the same number of the stages).

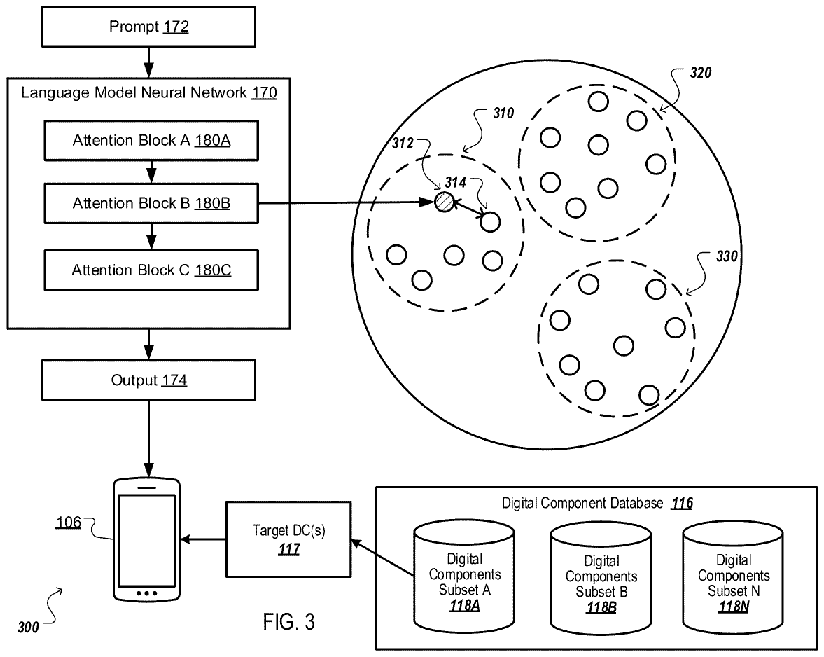

FIG. 3 illustrates example operations for selecting target digital components for presentation, according to an implementation of the present disclosure. These operations can be performed by the service apparatus 110 of FIG. 1. The service apparatus 110 includes the AI system 160, which in turn includes the language model 170.

The AI system 160 receives the prompt 172 and, in response, generates one or more outputs 174 using a language model 170 conditioned on the prompt 172. The language model 170 can be any appropriate language model neural network that receives a prompt 172 that is an input sequence made up of text tokens selected from a vocabulary and auto-regressively generates an output 174 that is an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

As illustrated in FIG. 3, the Transformer-based neural network includes a sequence of attention blocks, e.g., attention blocks A-C 180A-C, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

To identify a target stage from among the multiple stages within the user journey, the service apparatus 110 uses the output hidden states generated by one or more of the attention blocks during the processing of a prompt 172 to generate the output 174.

That is, the service apparatus 110 uses an intermediate embedding in a latent space that is generated by one of the attention blocks, e.g., intermediate embedding generated by the attention block B 180B, based on the prompt 172, and then identifies one or more reference embeddings in the latent space based on respective distances between the one or more reference embeddings and the intermediate embedding in the latent space.

For example, the intermediate embedding can include the plurality of output hidden states that have been generated by attention block for (at least some of) the input tokens in the prompt 172. A “hidden state” or an “embedding” as used in this specification is vector of numeric values, e.g., floating point values or other values, having a pre-determined dimensionality. The space of possible vectors having the pre-determined dimensionality is referred to as the “latent space.”

More generally, however, the intermediate embedding can include the output activations generated by the neurons of any intermediate neural network layer of the language model 170, or a combination of the output activations generated by the neurons of two or more intermediate layers of the language model 170, during the processing of the prompt 172 to generate the output 174. For example, instead of or in addition to being the final output of an attention block, the intermediate embedding can include the output of the self-attention layer, the output of the feed-forward layer, or both included in the attention block.

The reference embeddings can be generated previously by the language model 170, or another language model neural network, based on processing history prompts that correspond respectively to different stages within the alternate user journeys, e.g., different prompts that correspond to the problem awareness stage 210, the solution provider awareness stage 220, the solution consideration stage 230, the solution comparison stage 240, and the solution implementation stage 250, respectively, in the example user journey of FIG. 2.

In some cases, these history prompts can be the actual prompts submitted by different users over different stages of the alternate user journeys when accomplishing the computer-implemented task. In some other cases, these history prompts can be simulated prompts that are generated as outputs by the language model 170, e.g., based on context prompts, leveraging the generative power of the language model 170. The context prompts can for example include information available on the landing web pages.

The embeddings generated from these history prompts may capture semantic and/or syntactic properties of the history prompts, as well as the context of the stages during which the prompt was submitted. In some implementations, these embeddings may take the form of “reference” embeddings that represent previous knowledge of the history prompts gained by the language model 170 from the history prompts. Put another way, these reference embeddings map or project the history prompts to a latent space. These reference embeddings can then be used to identify, from among the plurality of stages within the user journey, a target stage that a new prompt 172 belongs to.

In the example of FIG. 3, the language model 170, or another language model neural network, has previously been used to generate various reference embeddings that belong to regions 310, 320, and 330 of latent space 300. Each region corresponds to a stage in the alternate user journeys. For example, region 310 can correspond to a first stage in the user journeys. A cluster of reference embeddings (small circles in FIG. 3) generated based on processing similar prompts that correspond to the first stage can reside in first region 310. Region 320 can correspond to a second stage in the user journeys. Another cluster of reference embeddings generated based on processing similar prompts that correspond to the second stage can reside in second region 320. And so on. These regions 310-330 may be defined in various ways, such as by using through the largest enclosing area, or “convex hull,” of all existing/known reference embeddings for a certain stage.

For an intermediate embedding 312 generated from a prompt 172, to determine which stage from among the plurality of stages within the user journey that the intermediate embedding 312 belongs to, one or more reference embeddings (small circles in FIG. 3) in latent space 310 can be identified based on one or more distances between the one or more reference embeddings and the intermediate embedding 312 in the latent space 300. These distances, or “similarities,” can be computed in various ways, such as with cosine similarity, dot products, or the like. For example, the reference embedding(s) that are closest to the intermediate embedding can be identified and used to determine a corresponding target stage.

In the example of FIG. 3, the intermediate embedding 312 is closest to a reference embedding 314 in latent space 300. The reference embedding 314 reside in the first region 310, which includes a cluster of reference embeddings generated based on processing prompts that correspond to the first stage within the alternate user journeys. Thus, in the example of FIG. 3, the service apparatus 110 determines that the intermediate embedding 312 maps to the first region, and correspondingly determines that, the prompt 172 based on which the intermediate embedding 312 has been generated, maps to the first stage within the user journey.

Once the target stage within the user journey has been determined, the service apparatus 110 can proceed to select one or more target digital components 117 from the available digital components that are mapped to the target stage. FIG. 3 thus illustrates that one or more target digital components 117 are selected from a subset of digital components 118A for delivery and presentation on the client device 106 together with the output 174 generated by the language model 170.

In particular, the service apparatus 110 can select any number of target digital components 117 from the subset of digital components 118A, which is a particular one of the multiple different subsets of digital components 118A-N stored in the database 116 that maps to the first stage within the user journey. For example, the database 116 can store each digital component in association with distribution parameters that contribute to (e.g., trigger, condition, or limit) the distribution/transmission of the corresponding digital component, and the service apparatus 110 can then select, as the target digital components, one or more digital components having distribution parameters that match (e.g., either exactly or with some pre-specified level of similarity) at least one criterion specified by, or otherwise derived from, the prompt 172 and/or the request for outputs 174.

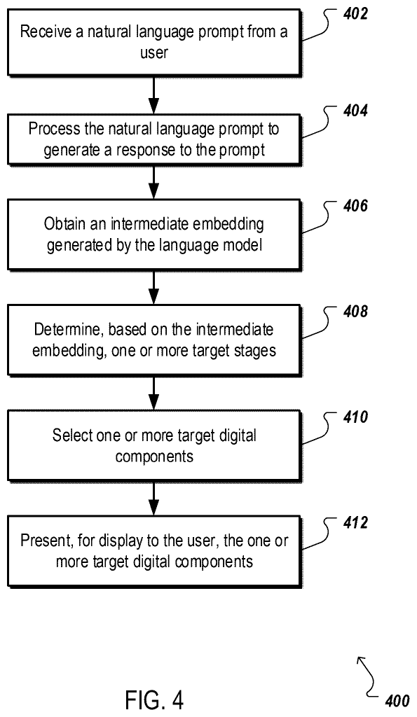

FIG. 4 is a flow diagram of an example process for selecting and presenting target digital components together with a response to a natural language prompt, according to an implementation of the present disclosure. Operations of the process 400 can be performed, for example, by the service apparatus 110 of FIG. 1, or another data processing apparatus. The operations of the process 400 can also be implemented as instructions stored on a computer readable medium, which can be non-transitory. Execution of the instructions, by one or more data processing apparatus, causes the one or more data processing apparatus to perform operations of the process 400.

A prompt is received from a user (402). The service apparatus can for example receive the prompt that is entered and submitted by the user through a client device. The prompt generally includes natural language text, i.e., includes a plurality of input tokens included in a vocabulary of text tokens that includes, e.g., one or more of characters, sub-words, words, punctuation marks, numbers, or other symbols that appear in natural language text.

A language model processes the prompt to generate a response to the prompt (404). The language model is typically trained to massive datasets of text and/or code to generate and understand human language and/or computer code. The response will similarly include natural language text, i.e., includes a plurality of output tokens included in the vocabulary of text tokens.

In some implementations, the language model is a Transformer-based neural network that includes a sequence of attention blocks, i.e., includes a plurality of attention blocks arranged in a sequence with the output of any block except the last being an input to another of the blocks. During the processing of the prompt, each attention block in the sequence receives a respective input hidden state for each input token in the prompt. The attention block then updates each of the hidden states at least in part by applying self-attention to generate a respective output hidden state for each of the input tokens.

An intermediate embedding is obtained (406). The intermediate embedding includes the output activations generated by the neurons of one or more intermediate layers of the language model during the processing of the natural language prompt to generate the response. For example, the intermediate embedding can include a plurality of output hidden states that have been generated by one of the attention blocks for (at least some of) the input tokens in the prompt.

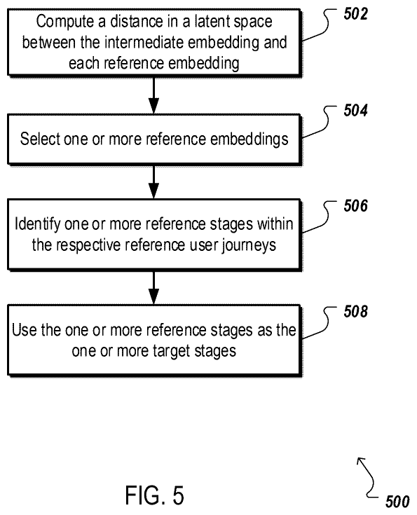

One or more target stages from among a plurality of different stages included in a user journey is determined based on the intermediate embedding (408). As discussed above, the user journey generally represents a process during which a user performs different actions to perform a computer-implemented task. Step 408 is explained in more detail with reference to FIG. 5, which shows sub-steps 502-508 corresponding to step 408.

Turning to FIG. 5, FIG. 5 is a flow diagram of sub-steps of one of the steps of the process of FIG. 4, according to an implementation of the present disclosure.

A distance in a latent space between the intermediate embedding and each reference embedding of a plurality of reference embeddings is computed (502). In some cases, the plurality of reference embeddings were generated by the language model based on processing history prompts provided by different users at different reference stages included in respective reference user journeys. In some other cases, the plurality of reference embeddings were generated by the language model based on processing simulated prompts that are a simulation of the history prompts that would have been provided by the different users at different reference stages included in respective reference user journeys. Such simulated prompts can for example be generated by using the language model leveraging its generative power.

One or more reference embeddings having distances in the latent space that satisfy a distance threshold are selected (504). For example, the service apparatus can select one or more reference embeddings that are closest, i.e., have the shortest distances, to the intermediate embedding from among all of the plurality of reference embeddings. As another example, the service apparatus can select one or more reference embeddings having distances with respect to the intermediate embedding that are each below a threshold distance value. These distances can be computed in various ways, such as with cosine similarity, dot products, or the like. As yet another example, the service apparatus can select one or more reference embeddings that are included in the same predefined region in the latent space as the intermediate embedding.

One or more reference stages within the respective reference user journeys are identified (506). That is, the service apparatus identifies one or more history prompts based on which the one or more reference embeddings selected at step 506 were generated by the language model, and correspondingly determines, as the reference stages, one or more stages within the respective reference user journeys during which the identified history prompts were received by the language model. The service apparatus can select one corresponding stage for each history prompt, e.g., can select two or more different stages in the situations where multiple history prompts are identified.

The one or more reference stages are used as the one or more target stages (508).

Returning to FIG. 4, one or more target digital components are selected from respective candidate digital components mapped to the one or more target stages (410). In some implementations, the available digital components are stored in a database in association with respective indices that represent different stages, and the service apparatus can select, as the one or more target digital components, any number of available digital components that are associated with the indices representing the reference stages, e.g., by sampling a digital component with uniform randomness, or by selecting a digital component having distribution parameters that match some criteria specified by, or otherwise derived from, the prompt.

The one or more target digital components are presented, for display to the user, together with the response to the prompt that has been generated by the language model (412). For example, the service apparatus can deliver both the target digital components and the response to the client device, which then presents them on a computer display of the client device.

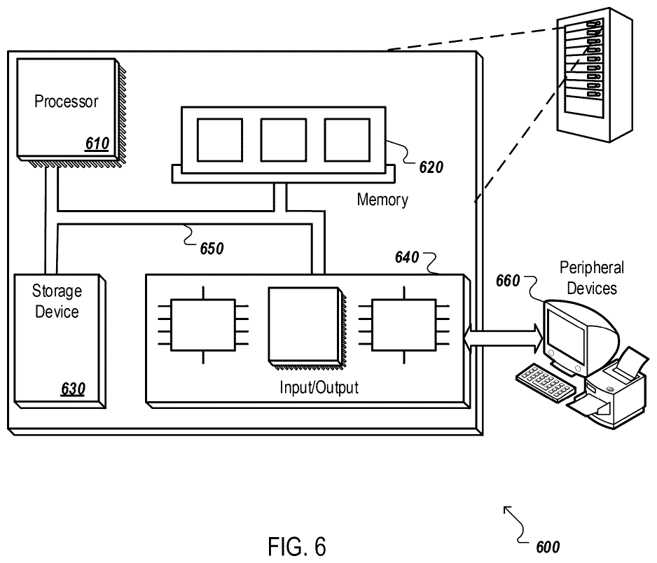

FIG. 6 is a block diagram of an example computer system 600 that can be used to perform operations described above, according to an implementation of the present disclosure. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more computers, comprising:
receiving a natural language prompt from a user;
processing, by a language model neural network, the natural language prompt to generate a response to the natural language prompt;
obtaining an intermediate embedding generated by the language model neural network during the processing of the natural language prompt to generate the response;
determining, based on the intermediate embedding, one or more target stages from among a plurality of different stages included in a user journey during which a user performs different actions to perform a computer-implemented task;
selecting, from respective candidate digital components mapped to the one or more target stages, one or more target digital components; and
presenting, for display to the user, the one or more target digital components together with the response to the natural language prompt that has been generated by the language model neural network.

2. The method of claim 1, wherein the computer-implemented task comprises:
navigating from a source web page, through a plurality of web pages, to arrive at a landing web page, wherein the landing web page represents a solution to a problem represented by the source web page.

3. The method of claim 1, wherein the plurality of different stages is a progression of different stages that comprise a problem awareness stage, followed by a solution provider awareness stage, followed by a solution consideration stage, followed by a solution comparison stage, and followed by a solution implementation stage.

4. The method of claim 1, wherein the intermediate embedding comprises:
an output of an intermediate neural network layer of the language model neural network.

5. The method of claim 1, wherein determining the one or more target stages from among the plurality of different stages included in the user journey comprises:
computing a distance in a latent space between the intermediate embedding and each reference embedding of a plurality of reference embeddings, wherein the plurality of reference embeddings were generated by the language model neural network based on processing history natural language prompts provided by different users at different reference stages included in respective reference user journeys;
selecting one or more reference embeddings having distances that satisfy a distance threshold;
identifying one or more reference stages within the respective reference user journeys during which the one or more reference embeddings were generated by the language model neural network; and
using the one or more reference stages as the one or more target stages.

6. The method of claim 5, comprising:
using the language model neural network to generate, based on information available on the landing web page, additional history natural language prompts that represent the history natural language prompts that would be provided by the different users at the different reference stages included in the respective reference user journeys.

7. The method of claim 1, wherein selecting the one or more target digital components comprises:
receiving, from a digital component provider, and for each stage of the plurality of different stages included in the user journey, respective candidate digital components associated with each stage.

8. (canceled)

9. A non-transitory computer storage medium encoded with instructions that, when executed by one or more computers, cause the one or more computers to perform operations comprising
receiving a natural language prompt from a user;
processing, by a language model neural network, the natural language prompt to generate a response to the natural language prompt;
obtaining an intermediate embedding generated by the language model neural network during the processing of the natural language prompt to generate the response;
determining, based on the intermediate embedding, one or more target stages from among a plurality of different stages included in a user journey during which a user performs different actions to perform a computer-implemented task;
selecting, from respective candidate digital components mapped to the one or more target stages, one or more target digital components; and
presenting, for display to the user, the one or more target digital components together with the response to the natural language prompt that has been generated by the language model neural network.

10. The non-transitory computer storage medium of claim 9, wherein the computer-implemented task comprises:
navigating from a source web page, through a plurality of web pages, to arrive at a landing web page, wherein the landing web page represents a solution to a problem represented by the source web page.

11. The non-transitory computer storage medium of claim 9, wherein the plurality of different stages is a progression of different stages that comprise a problem awareness stage, followed by a solution provider awareness stage, followed by a solution consideration stage, followed by a solution comparison stage, and followed by a solution implementation stage.

12. The non-transitory computer storage medium of claim 9, wherein the intermediate embedding comprises:
an output of an intermediate neural network layer of the language model neural network.

13. The non-transitory computer storage medium of claim 9, wherein determining the one or more target stages from among the plurality of different stages included in the user journey comprises:
computing a distance in a latent space between the intermediate embedding and each reference embedding of a plurality of reference embeddings, wherein the plurality of reference embeddings were generated by the language model neural network based on processing history natural language prompts provided by different users at different reference stages included in respective reference user journeys;
selecting one or more reference embeddings having distances that satisfy a distance threshold;
identifying one or more reference stages within the respective reference user journeys during which the one or more reference embeddings were generated by the language model neural network; and
using the one or more reference stages as the one or more target stages.

14. The non-transitory computer storage medium of claim 13, wherein the instructions cause the one or more computers to perform operations further comprising:
using the language model neural network to generate, based on information available on the landing web page, additional history natural language prompts that represent the history natural language prompts that would be provided by the different users at the different reference stages included in the respective reference user journeys.

15. The non-transitory computer storage medium of claim 9, wherein selecting the one or more target digital components comprises:
receiving, from a digital component provider, and for each stage of the plurality of different stages included in the user journey, respective candidate digital components associated with each stage.

16. A system, comprising:
one or more computers; and
one or more storage devices storing instructions, that upon execution, cause the one or more computers to perform operations comprising:
receiving a natural language prompt from a user;
processing, by a language model neural network, the natural language prompt to generate a response to the natural language prompt;
obtaining an intermediate embedding generated by the language model neural network during the processing of the natural language prompt to generate the response;
determining, based on the intermediate embedding, one or more target stages from among a plurality of different stages included in a user journey during which a user performs different actions to perform a computer-implemented task;
selecting, from respective candidate digital components mapped to the one or more target stages, one or more target digital components; and
presenting, for display to the user, the one or more target digital components together with the response to the natural language prompt that has been generated by the language model neural network.

17. The system of claim 16, wherein the computer-implemented task comprises:
navigating from a source web page, through a plurality of web pages, to arrive at a landing web page, wherein the landing web page represents a solution to a problem represented by the source web page.

18. The system of claim 16, wherein the plurality of different stages is a progression of different stages that comprise a problem awareness stage, followed by a solution provider awareness stage, followed by a solution consideration stage, followed by a solution comparison stage, and followed by a solution implementation stage.

19. The system of claim 16, wherein the intermediate embedding comprises:
an output of an intermediate neural network layer of the language model neural network.

20. The system of claim 16, wherein determining the one or more target stages from among the plurality of different stages included in the user journey comprises:
computing a distance in a latent space between the intermediate embedding and each reference embedding of a plurality of reference embeddings, wherein the plurality of reference embeddings were generated by the language model neural network based on processing history natural language prompts provided by different users at different reference stages included in respective reference user journeys;
selecting one or more reference embeddings having distances that satisfy a distance threshold;
identifying one or more reference stages within the respective reference user journeys during which the one or more reference embeddings were generated by the language model neural network; and
using the one or more reference stages as the one or more target stages.

21. The system of claim 20, wherein the instructions cause the one or more computers to perform operations further comprising:
using the language model neural network to generate, based on information available on the landing web page, additional history natural language prompts that represent the history natural language prompts that would be provided by the different users at the different reference stages included in the respective reference user journeys.
